(19) United States
(12) Patent Application Publication
(10) Pub. No.: US 2008/0286002 A1
(43) Pub. Date: Nov. 20, 2008

(54) IMAGE FORMING APPARATUS

(75) Inventor: Takaya Akiyama, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/016,464

(22) Filed: Jan. 18, 2008

(30) Foreign Application Priority Data
Jan. 22, 2007 (JP) 2007-011339

(51) Int. Cl. G03G 15/00

(52) U.S. Cl. 399/114

(57) ABSTRACT

An image forming apparatus is provided with a box-shaped apparatus main body internally including an image forming assembly and a sheet feeding assembly, an apparatus front cover located on the front surface of the apparatus main body and having a plurality of unit cover members that can be opened forward and are vertically arranged one above the other, and grips provided on the respective cover members and used to open the unit cover members. The apparatus front cover has a rectangular shape when the front surface of the apparatus main body is viewed from front, and includes a projecting flat surface projecting forward from the peripheral edges of the apparatus front cover and inclined surfaces formed to extend from the left, right and upper sides of the projecting flat surface toward the peripheral edges of the apparatus front cover. The grips are vertically arranged on the projecting flat surface.

### BACKGROUND OF THE INVENTION

1. Field of the Invention

The present invention relates to an image forming apparatus such as a printer, a copier, a facsimile machine or a complex machine having functions of these apparatuses.

2. Description of the Related Art

There has been known an image forming apparatus of the so-called internal discharge type in which an image reader is arranged via a discharge unit atop an apparatus main body internally provided with an image forming assembly and a sheet feeding assembly and which has an apparatus front cover provided on the front surface thereof as disclosed, for example, in Japanese Unexamined Patent Publications Nos. 2006-58689 and 2004-355019. This apparatus front cover is comprised of an opening cover for covering the image forming assembly and decorative covers for a plurality of sheet cassettes vertically arranged one above the other.

Normally, the opening cover is a door-type cover rotatably mounted on the apparatus main body at the left or right side and is opened and closed at the time of jam, maintenance or other occasion. On the other hand, the sheet cassettes are drawer-type boxes withdrawable forward, and are slid in forward and backward directions at the time of replenishing sheets or other occasion. In order to facilitate the opening/closing movements and withdrawing movements as described above, the opening cover and the sheet cassettes are respectively provided with grips to be held by a user at the front side of the apparatus main body, i.e. on the apparatus front cover.

However, in the conventional image forming apparatus, the apparatus main body has a box structure in the form of a rectangular column and the apparatus front cover covering the front surface thereof is a substantially flat surface. Thus, when the user exactly faces the front surface of the image forming apparatus, he or she tends to recognize the entire front surface of the apparatus main body as a simple flat surface and there are cases where the grips are visually embedded in this flat surface and the positions thereof cannot be immediately visually confirmed. Accordingly, it cannot be said that accessibility to the opening covers and the sheet cassettes is good, which is seen as a problem in image forming apparatuses of recent years required to have high operability.

### SUMMARY OF THE INVENTION

An object of the present invention is to improve accessibility to grips used for opening operations and provided on the front surface of an apparatus main body.

In order to accomplish this object, one aspect of the present invention is directed to an image forming apparatus, comprising a box-shaped apparatus main body internally provided with an image forming assembly and a sheet feeding assembly; an apparatus front cover located on the front surface of the apparatus main body and having a plurality of unit cover members that can be opened forward and are vertically arranged one above the other; and grips provided on the respective unit cover members and used to open the unit cover members. The apparatus front cover has a rectangular shape when the front surface of the apparatus main body is viewed from front and includes a projecting flat surface projecting more forward than the peripheral edges of the apparatus front cover and inclined surfaces formed to extend from the left, right and upper sides of the projecting flat surface toward the peripheral edges of the apparatus front cover. The grips are vertically arranged one above the other on the projecting flat surface.

These and other objects, features, aspects and advantages of the present invention will become more apparent upon a reading of the following detailed description and accompanying drawings.

### BRIEF DESCRIPTION OF THE DRAWINGS

FIG. 1 is a perspective view showing the external appearance of a copier as an example of an image forming apparatus according to the present invention,

FIG. 2 is a section schematically showing the internal construction of the copier,

FIG. 3 is a front perspective view enlargedly showing a part above an apparatus front cover and near a discharge unit of the copier shown in FIG. 1,

FIGS. 4A to 4G are diagrams showing variations of inclined surfaces,

FIGS. 5A to 5F are diagrams showing variations of arcuate inclined surfaces,

FIGS. 6A and 6B are diagrams showing accessibility to grips, and

FIG. 7 is a perspective view showing the external appearance of a copier according to a modification.

### DETAILED DESCRIPTION OF THE PREFERRED EMBODIMENTS

Hereinafter, one specific embodiment of the present invention is described with reference to the accompanying drawings.

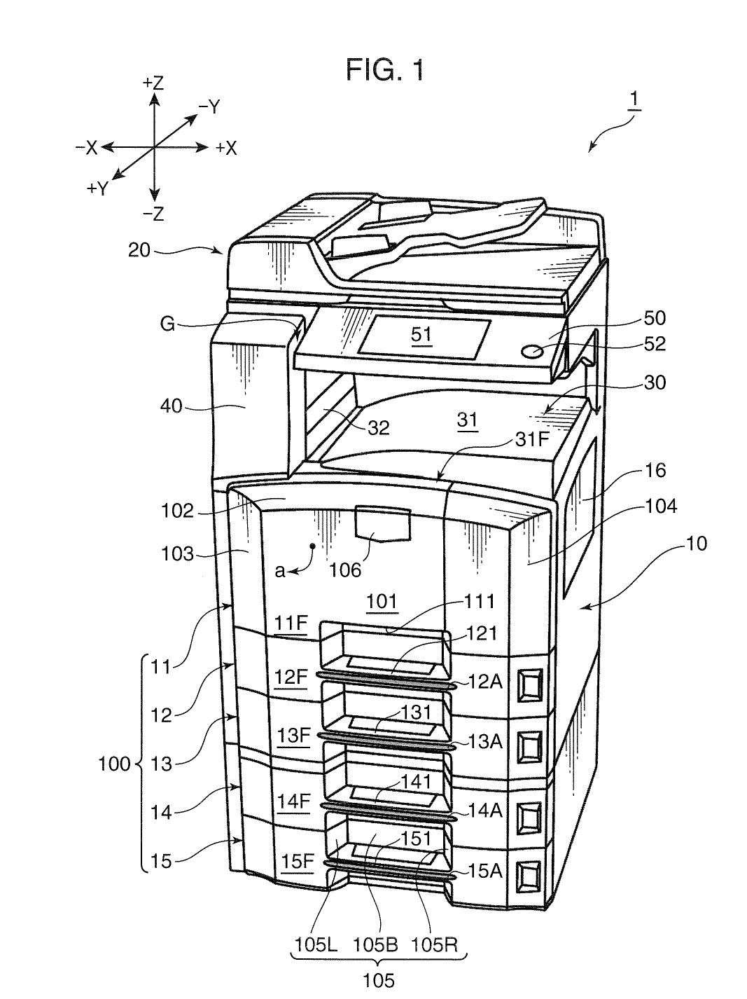

FIG. 1 is a perspective view showing the external appearance of a copier 1 as an example of an image forming apparatus according to the present invention. In FIG. 1 and other figures, X-X directions are transverse directions, Y-Y directions are forward and backward directions, and Z-Z directions are vertical directions, wherein +X direction is rightward direction; −X direction leftward direction; +Y direction forward direction; −Y direction backward direction; +Z direction upward direction; and −Z direction downward direction.

The copier 1 is of the so-called internal discharge type, and is provided with a box-shaped apparatus main body 10 internally including an image forming assembly and a sheet feeding assembly, an image reader 20 arranged atop the apparatus main body 10, and a discharge unit 30 which is arranged between the apparatus main body 10 and the image reader 20, to which a sheet after image formation is discharged and which is open at least at front for the removal of the sheet.

An apparatus front cover 100 constructed such that a plurality of unit cover members, which can be opened forward, are vertically arranged is provided on the front surface of the apparatus main body 10. In this embodiment is shown an example in which the unit cover members of the apparatus front cover 100 include a decorative surface 11F of an opening cover 11 arranged at the uppermost position and decorative covers 12F to 15F of first to fourth sheet cassettes 12 to 15 arranged one below another in vertical direction below the decorative surface 11F.

As shown by an arrow “a” in FIG. 1, the opening cover 11 can be opened and closed in a front left direction about the left end thereof as a rotary shaft. On the other hand, the first to fourth sheet cassettes 12 to 15 are respectively so mounted in the apparatus main body 10 as to be withdrawable forward. Further, the opening cover 11 and the first to fourth sheet cassettes 12 to 15 are respectively provided with grips 111, 121, 131, 141 and 151 used for their opening/closing movements.

The apparatus front cover 100 has a vertically long rectangular shape when the front surface of the apparatus main body 10 is viewed from front. The apparatus front cover 100 includes a projecting flat surface 101 projecting more forward than the peripheral edges of the apparatus front cover 100, and three inclined surfaces formed to extend from the end edges of the projecting flat surface 101 to the peripheral edges of the apparatus front cover 100. The three inclined surfaces include an arcuate inclined surface 102 formed from the upper side of the projecting flat surface 101 to the upper peripheral edge of the apparatus front cover 100, and left and right inclined surfaces 103, 104 formed from the left and right sides of the projecting flat surface 101 to the left and right peripheral edges of the apparatus front cover 100.

A recessed part 105 vertically extending over the decorative surface 11F of the opening cover 11 and the decorative covers 12F to 15F of the first to fourth sheet cassettes 12 to 15 is formed at a transverse middle position of the projecting flat surface 101. The recessed part 105 includes a bottom surface 105B recessed by a specified depth relative to the projecting flat surface 101, and a pair of left and right inclined surfaces 105L, 105R formed to extend from the bottom surface 105B toward the opening edge in such a manner as to increase the opening width.

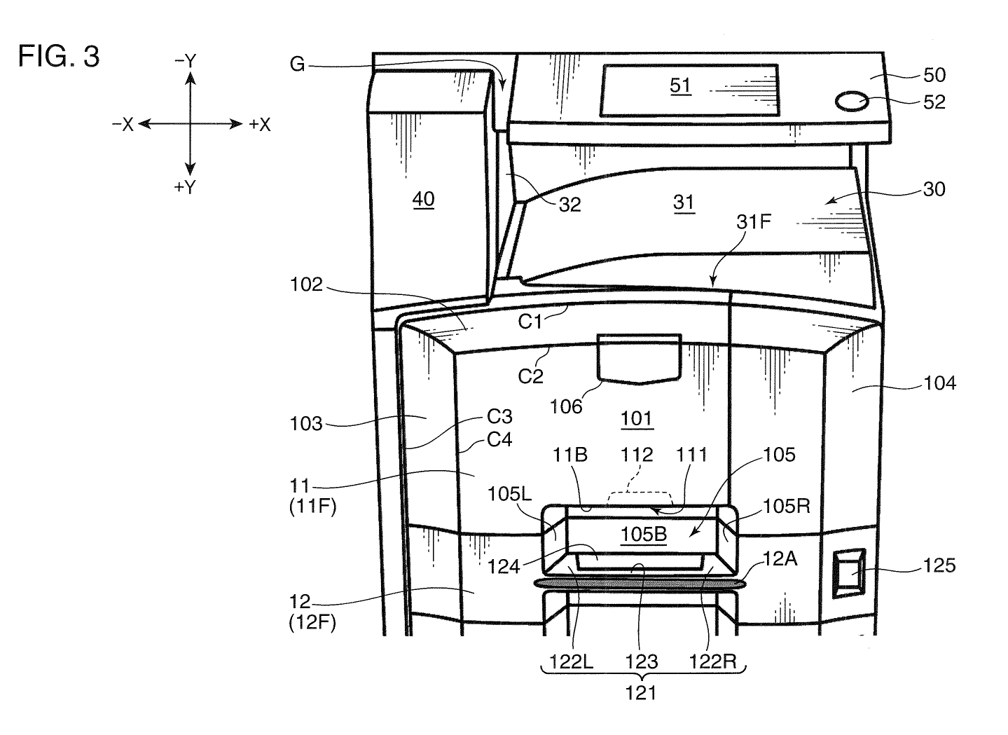

The aforementioned grips 111 to 151 are arranged in vertical direction in this recessed part 105. Further, colored portions 12A, 13A, 14A and 15A narrow and long in transverse direction and having a color different from that of the projecting flat surface 101 are provided on the front sides of the grips 121 to 151 of the first to fourth sheet cassettes 12 to 15. Further, an emblem 106 is attached at an upper middle position of the apparatus front cover 100 (opening cover 11). The construction of such an apparatus front cover 100 is described in more detail later with reference to FIGS. 3 to 6B.

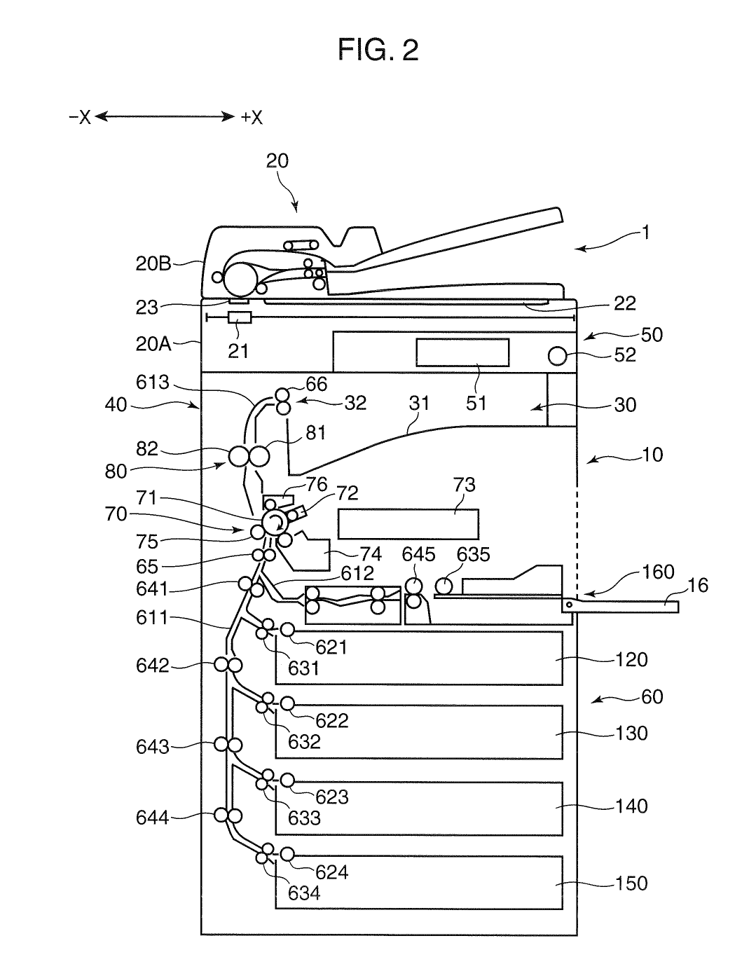

The image reader 20 is arranged atop the apparatus main body 10 via a space for the discharge unit 30. The image reader 20 is supported by a supporting column 40 arranged at the left side of the upper surface of the apparatus main body 10 and a side wall arranged at the back side of the upper surface of the apparatus main body 10. This image reader 20 includes an automatic document feed unit 20B for feeding a document to be copied to a document reading position and thereafter discharging the document and a scanner unit 20A having an optical system for reading the image of the document (see FIG. 2).

The discharge unit 30 is a unit to which a sheet having an image formed thereon in the apparatus main body 10 in accordance with a document image read by the image reader 20 is discharged and includes a discharge tray 31 and a discharge port 32. The discharge port 32 is an opening formed in the right surface (surface facing the discharge unit 30) of the supporting column 40 and enabling a sheet after image formation to be discharged from the apparatus main body 10. The discharge tray 31 is a sheet receiving surface for receiving the sheet being discharged from this discharge port 32. The discharge tray 31 is a surface moderately inclined downward from right to left when viewed from front, and a part adjacent to the discharge port 32 is located at the lowest position. By such an inclination, sheets discharged from the discharge port 32 to the discharge tray 31 can have the trailing ends thereof in a sheet conveying direction aligned near the discharge port 32.

The supporting column 40 located at the left side of the discharge unit 30 has substantially the same dimension as the apparatus main body 10 in forward and backward directions. In other words, the front end (front surface) of the supporting column 40 is located substantially at the same position as a front end 31F of the discharge tray 31. On the other hand, the front end of the image reader 20 is retracted by a specified length from the front end 31F of the discharge tray 31.

An operation panel 50 is mounted on the front surface of the image reader 20. The operation panel 50 is so arranged as to take up a space before the image reader 20 and above the discharge tray 31.

A clearance G is formed between the operation panel 50 and the supporting column 40. This enables a user to see a part of the internally arranged discharge tray 31 through the clearance G from above. Particularly, since this clearance G is located substantially right above the discharge port 32 and corresponds to the bottommost position of the discharge tray 31 where the trailing ends of the discharge sheets in the sheet conveying direction are aligned, the user can reliably see whether or not there is any sheet on the discharge tray 31 or whether or not a sheet is about to be discharged.

The operation panel 50 is for receiving various operation instructions and setting instructions from the user. Here are shown an operation display 51 including a liquid crystal display (LCD) or the like for displaying operation guide information and the like used to input the setting and the like for various copying operations and displaying various operation buttons and the like, and a start key 52 used by the user to enter a print instruction. Besides these, a numeric keypad and the like for receiving inputs such as the number of copies to be printed are provided.

Next, the internal construction of the copier 1 is described. FIG. 2 is a section schematically showing the internal construction of the copier 1. As described above, the copier 1 is provided with the apparatus main body 10 having the supporting column 40 on the upper surface, the image reader 20, the discharge unit 30 and the operation panel 50. The apparatus main body 10 is internally provided with the sheet feeding assembly 60, the image forming assembly 70 and a fixing device 80.

The image reader 20 includes the scanner unit 20A and the automatic document feed unit 20B arranged atop the scanner unit 20A. The scanner unit 20A internally includes a movable frame 21 having an exposure lamp for irradiating the document with light. In addition, a CCD (Charge Coupled Device) sensor for generating an image data by photoelectrically converting reflected light from a document, an optical system for introducing the reflected light to the CCD sensor and the like are built in the scanner unit 20A although they are not shown. Furthermore, a first platen glass 22 for reading a placed document and a second platen glass 23 for reading automatically fed documents are provided on the upper surface of the scanner unit 20A.

The automatic document feed unit 20B includes a feed tray for storing documents to be read, and a receiving portion for receiving the documents after the reading. The automatic document feed unit 20B feeds the documents from the feed tray to the document reading position of the second platen glass 23 and discharges the documents after the reading to the receiving portion by the operation of a document conveying mechanism provided inside.

The sheet feeding assembly 60 of the apparatus main body 10 is for feeding a sheet (recording sheet) to the image forming assembly 70. The sheet feeding assembly 60 includes first to fourth sheet storing portions 120 to 150 respectively corresponding to the aforementioned first to fourth sheet cassettes 12 to 15 and adapted to accommodate sheets of various sizes, and a manual sheet feeder 160 comprised of a manual feed tray 16 openably and closably mounted at the right side of the apparatus main body 10. Although not shown, the first to fourth sheet storing portions 120 to 150 include cursors for positioning sheet stacks, lifters for bringing the uppermost sheets into contact with pickup rollers 621 to 624 to be described later by elastically lifting the sheet stacks, and the like.

Sheet conveyance paths for conveying sheets are provided from such a sheet feeding assembly 60 to the discharge port 32 via the image forming assembly 70 and the fixing device 80. Such sheet conveyance paths include a first sheet conveyance path 611 extending from the first to fourth sheet storing portions 120 to 150 to the image forming assembly 70, a second sheet conveyance path 612 extending from the manual sheet feeder 160 to the image forming assembly 70 and a third sheet conveyance path 613 extending from the image forming assembly 70 to the discharge port 32.

The pickup rollers 621, 622, 633 and 624 for picking up the accommodated sheets one by one and feed roller pairs 631, 632, 633 and 634 arranged downstream of these pickup rollers are provided at upper parts of sheet take-out sides of the first to fourth sheet storing portions 120 to 150. The feed roller pairs 631, 632, 633 and 634 are for feeding the picked-up sheets to the first sheet conveyance path 611.

The first sheet conveyance path 611 includes conveyance roller pairs 641, 642, 643 and 644 for conveying the sheet to the image forming assembly 70. The second sheet conveyance path 612 includes a feed roller 635 for taking in a manually fed sheet and a conveyance roller pair 645 for conveying this manually fed sheet toward the image forming assembly 70. Further, a registration roller pair 65 for causing the sheet to wait on standby before the image forming assembly 70 is provided at an end position of the first sheet conveyance path 611. A discharge roller pair 66 for conveying (discharging) the sheet toward the discharge unit 30 is arranged at an end position of the third sheet conveyance path 613, and the discharge port 32 is so provided as to extend along the discharge roller pair 66.

The image forming apparatus 70 transfers a toner image to a sheet conveyed from the sheet feeding assembly 60 based on the image data of a document obtained in the image reader 20. The image forming apparatus 70 includes a photoconductive drum 71 rotatably provided about an axis, and a charger 72, an exposing device 73, a developing device 74, a transfer roller 75 and a cleaning device 76 arranged along the circumferential surface of the photoconductive drum 71.

The photoconductive drum 71 is for forming an electrostatic latent image and a toner image in conformity with this electrostatic latent image on the circumferential surface thereof. An amorphous silicon photoconductive drum having an amorphous silicon layer formed on the circumferential surface thereof is suitably used as the photoconductive drum 71.

The charger 72 is for uniformly charging the circumferential surface of the photoconductive drum 71 rotating clockwise about its center axis. A charger of the type to impart electric charges to the circumferential surface of the photoconductive drum 71 by corona discharge can be used as the charger 72. Alternatively, a charging roller for imparting electric charges to the photoconductive drum 71 while being rotated by the photoconductive drum 71 with the circumferential surface thereof held in contact with the circumferential surface of the photoconductive drum 71 may be used.

The exposing device 73 irradiates the circumferential surface of the rotating photoconductive drum 71 with a laser beam modulated based on the image data. Electric charges are removed from parts of the circumferential surface of the photoconductive drum 71 irradiated with the laser beam, whereby an electrostatic latent image in conformity with a laser beam irradiation pattern is formed on the circumferential surface of the photoconductive drum 71.

The developing device 74 supplies toner particles to the circumferential surface of the photoconductive drum 71 via a developing roller built therein. When the toner particles are supplied to the photoconductive drum 71, they are attached to a part where the electrostatic latent image is formed, whereby a toner image is formed on the circumferential surface of the photoconductive drum 71. An unillustrated toner container is detachably attached to the developing device 74, and toner particles are resupplied from this toner container when the toner particles in the developing device 74 are used up.

The transfer roller 75 forms a nip portion together with the photoconductive drum 71 and transfers the toner image formed on the circumferential surface of the photoconductive drum 71 to a sheet fed to the nip portion. The toner image on the circumferential surface of the photoconductive drum 71 is positively charged. On the other hand, the transfer roller 75 imparts negative electric charges having a polarity opposite to the electric charges of the toner image to the sheet. The positively charged toner image on the circumferential surface of the photoconductive drum 71 is peeled off toward the front surface of the negatively charged sheet to be transferred to the sheet.

The cleaning device 76 cleans the circumferential surface of the photoconductive drum 71 by removing the toner residual thereon after a transfer process. The circumferential surface of the photoconductive drum 71 cleaned by this cleaning device 76 moves toward the charger 72 again for a next image forming process.

The fixing device 80 is for fixing the toner image transferred to the sheet in the image forming apparatus 70 to the sheet by heating. The fixing device 80 includes a heat roller 81 having an electric heating element mounted therein and a pressure roller 82 whose circumferential surface is opposed to that of the heat roller 81. The sheet after the transfer process passes through a nip portion between the heat roller 81 driven to rotate and the pressure roller 82 rotated by the heat roller 81 in an opposite direction to have a fixing process applied thereto by obtaining heat from the heat. The sheet having the fixing process applied thereto is discharged to the discharge unit 30 via the third sheet conveyance path 613 and the discharge roller pair 66.

Next, the detailed construction of the apparatus front cover 100 is described with reference to FIGS. 3 to 6B. FIG. 3 is a front perspective view enlargedly showing a part above the apparatus front cover 100 and near the discharge unit 30 of the copier 1 shown in FIG. 1. As described above, the apparatus front cover 100 includes the projecting flat surface 101, the three inclined surfaces formed around the projecting flat surface 101, i.e. the arcuate inclined surface 102, the left inclined surface 103 and the right inclined surface 104. Further, the recessed part 105 is formed at the transverse middle position of the projecting flat surface 101, and the grips 111 to 151 are vertically arranged in the recessed part 105.

The projecting flat surface 101 has a vertically long rectangular shape similar to the shape defined by the peripheral edges of the apparatus front cover 100 when viewed from front (see FIG. 1). The surface shape of the projecting flat surface 101 is a flat surface or a slightly convex or concave surface.

The arcuate inclined surface 102, the left inclined surface 103 and the right inclined surface 104 are inclined surfaces extending backward from the upper, left and right sides of the projecting flat surface 101. Angles of inclination of these inclined surfaces are preferably selected from such a range that angles of intersection with the projecting flat surface 101 (assumed to be flat) are 30° to 70°.

Further, the arcuate inclined surface 102, the left inclined surface 103 and the right inclined surface 104 preferably have considerable widths so that the projection of the projecting flat surface 101 can be easily visually recognized. For example, the widths of the left and right inclined surfaces 103, 104 in transverse direction are preferably about 0.05 to 0.3 times as large as the width of the projecting flat surface 101 in transverse direction. The width of the arcuate inclined surface 102 in vertical direction preferably has the same ratio to the width of the projecting flat surface 101 in transverse direction. Of course, the angles of inclination and the widths of the arcuate inclined surface 102, the left inclined surface 103 and the right inclined surface 104 may differ from each other or may be equal.

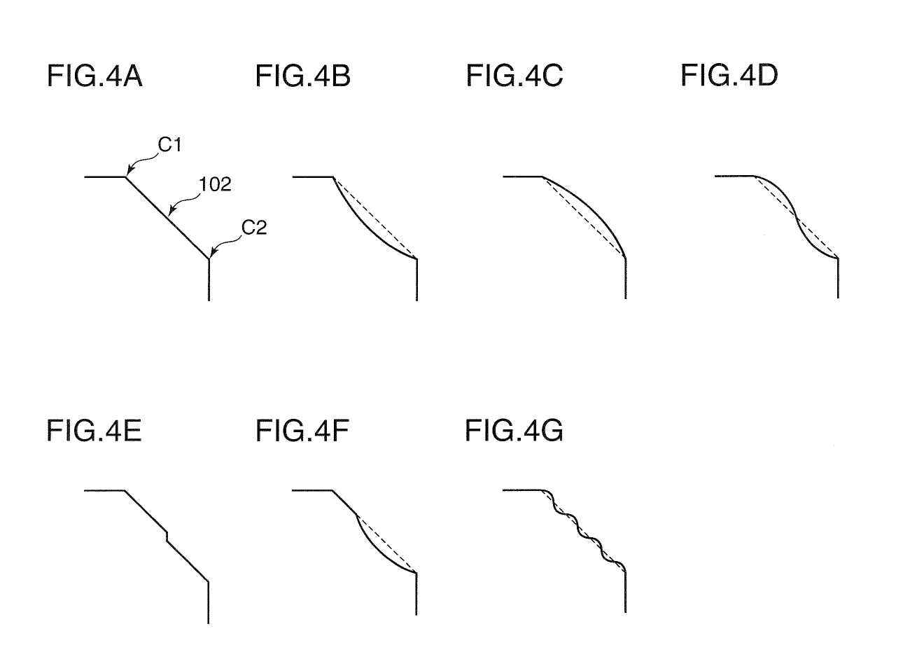

The arcuate inclined surface 102, the left inclined surface 103 and the right inclined surface 104 may be so-called “C-surfaces (chamfered surfaces)” formed by chamfering corners of a cube or may be surface approximate to the C-surfaces. FIGS. 4A to 4G show variations of adoptable inclined surfaces.

FIG. 4A shows a section between an upper arcuate line C1 and a lower arcuate line C2 forming the contour of the arcuate inclined surface 102. FIG. 4A shows a so-called “C-surface”, i.e. an inclined surface sloped down straight from the upper actuate line C1 adjacent to the front end 31F of the discharge tray 31 toward the lower arcuate line C2.

FIGS. 4B to 4G illustrate inclined surfaces approximate to the C-surface. FIG. 4B shows an inclined surface slightly concave relative to a straight inclined surface (shown in dotted line in FIG. 4B and the same holds true for the following inclined surfaces). FIG. 4C is an inclined surface slightly convex relative to the straight inclined surface. FIG. 4D shows a convexo-concave surface in which a convex surface and a concave surface are connected. FIG. 4E is a straight inclined surface with a stepped portion provided in the middle. FIG. 4F shows an inclined surface in which a straight surface and a concave surface are connected. FIG. 4G shows a wavy inclined surface. The shapes illustrated in FIGS. 4A to 4G or those similar to these can be adopted for the inclined shapes of the arcuate inclined surface 102, the left and right inclined surfaces 103, 104.

The arcuate inclined surface 102 is provided at the top of the opening cover 11 (decorative surface 11F) located right below the discharge tray 31. The arcuate inclined surface 102 is an arcuate surface having the upper arcuate line C1 defining the upper contour at the upper peripheral edge of the opening cover 11 and the lower arcuate line C2 defining the lower contour at the upper edge of the projecting flat surface 101. The upper and lower arcuate lines C1, C2 are moderately curved arcuate lines having transverse centers located at highest positions and lowered toward the opposite ends.

On the other hand, the left inclined surface 103 has the contour thereof defined by an outer straight line C3 vertically extending along the left peripheral edge of the apparatus front cover 100 and an inner straight line C4 vertically extending along the left edge of the projecting flat surface 101. The right inclined surface 104 has the contour thereof similarly defined. As shown in FIG. 1, the left and right inclined surfaces 103, 104 vertically extend over the left and right sides of all of the decorative surface 11f of the opening cover 11 and the decorative covers 12F to 15F of the first to fourth sheet cassettes 12 to 15.

As described above, the apparatus front cover 100 of this embodiment includes the arcuate inclined surface 102 extending along the front end 31F of the discharge tray 31 and inclined down toward the front in the part adjacent to the discharge tray 31. The upper and lower arcuate lines C1, C2 defining the contour of such an arcuate inclined surface 102 are almost only curved lines in the front view of the apparatus main body 10. In other words, the outer contour of the apparatus main body 10, a connection line between the opening cover 11 and the first sheet cassette 12 and connection lines between the first to fourth sheet cassettes 12 to 15 are straight lines, and the contours of the left and right inclined surfaces 103, 104 are also defined by the outer straight lines C3 and the inner straight lines C4.

In such a shape, only the arcuate inclined surface 102 have a curved shape convex toward the discharge unit 30. This provides a visual effect of improving accessibility to the discharge unit 30 for a user facing the front surface of the copier 1. Specifically, the discharge unit 30 is of the internal discharge type, and the discharge end of a sheet after image formation tends to be structurally difficult to see as compared to top and side discharge types. However, since a peculiar arcuate surface as compared to other parts is provided adjacent to the discharge unit 30, an effect of guiding the gaze to the discharge unit 30 can be given rise to.

In addition, since the arcuate inclined surface 102 is the inclined surface sloped down toward the front, users recognize bright reflected light close to specularly reflected light of illumination for the arcuate inclined surface 102 in an office or the like under normal ceiling illumination in many cases. On the other hand, users solely recognize diffused reflected light for the projecting flat surface 101 and other parts. Coupling the aforementioned shape effect of the arcuate surface and this effect of reflected light, the arcuate inclined surface 102 is seen as a “striking surface” by users, whereby accessibility to the discharge unit 30 can be further improved.

The “arcuate” in the arcuate inclined surface 102 does not indicate a perfect arc and includes a shape similar to the arc. Since the arcuate inclined surface 102 is provided to the effect of improving accessibility to the discharge unit 30 (discharge tray 31), it is sufficient to have an arcuate or similar contour line at least in the vicinity of the front end 31F of the discharge unit 31.

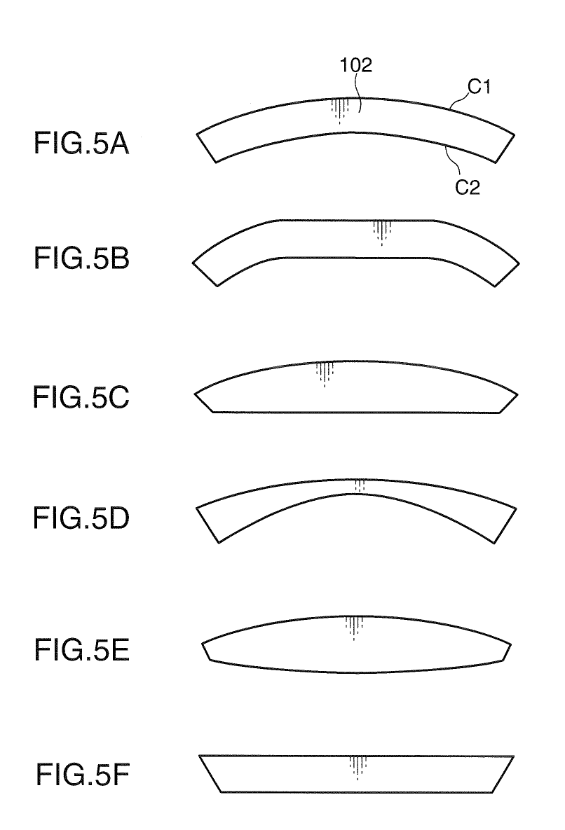

FIGS. 5A to 5F show variations of the shape of the arcuate inclined surface 102. FIG. 5A shows the shape of the arcuate inclined surface 102 illustrated in FIG. 1. The one shown in FIG. 5A is the arcuate inclined surface 102 having a meniscus shape in which the upper and lower arcuate lines C1, C2 are upward convex curves (convex toward the discharge tray 31). The shapes of the lateral sides of the arcuate inclined surface 102 are arbitrary and may be suitable straight lines, curves or R-surfaces in view of connection with the left and right inclined surfaces 103, 104.

FIGS. 5B to 5E illustrate shapes similar to “arcuate” surfaces. FIG. 5B shows an arcuate surface in which both upper and lower arcuate lines are straight in their middle parts and the opposite ends thereof are curved. FIG. 5C shows a surface shape in which upper contour line is an arcuate line, but the lower contour line is a straight line. FIG. 5D shows an arcuate surface in which the lower arcuate line has a smaller radius of curvature than the upper arcuate line. FIG. 5E shows a surface shape in which the upper contour line is an upward convex line, but the lower contour line is downward convex line. Besides, the upper arcuate line C1 may be such that the transverse center position is not located at a highest position and, for example, may be such that a position corresponding to the bottommost part of the discharge unit 31 is located at a highest position. Further, as shown in FIG. 5F, a trapezoidal inclined surface may be adopted instead of the arcuate surface.

Next, the grips 111, 121, 131, 141, 151 are vertically arranged one above the other at a transverse middle position of the apparatus front cover 100 (projecting flat surface 101) (see FIG. 1). These grips 111 to 151 are so provided as not to substantially project forward from the projecting flat surface 101 by utilizing the recessed part 105 likewise formed at the transverse middle position of the projecting flat surface 101. In this way, the projected area of the copier 1 is suppressed.

The recessed part 105 is formed by recessing transverse middle parts of the decorative covers 12F to 15F of the first to fourth sheet cassettes 12 to 15 by a specified width over the entire vertical thicknesses of the decorative covers 12F to 15F and by recessing a bottom section of a transverse middle part of the decorative surface 11F of the opening cover 11 by the specified width (recessed portion 11B). The depth of the bottom surface 105B of the recessed part 105 is set such that the user can insert his or her hand without any problem.

The inclined surfaces 105L, 105R of the recessed part 105 are inclined surfaces extending over the entire vertical dimension of the recessed part 105 and parallel to the left and right inclined surfaces 103, 104, viewed from front. By the presence of the pair of inclined surfaces 105L, 105R of this recessed part 105 in addition to that of the left and right inclined surfaces 103, 104, the transverse middle position of the projecting flat surface 101 where the grips 111 to 151 are arranged is further visually intensified.

The grip 111 of the opening cover 11 includes a catch portion 112 provided in the recessed portion 11B at the bottom end of the opening cover 11. This catch portion 112 is formed by recessing a part of the upper wall surface of the recessed portion 11B, enables the insertion of fingers thereinto and is formed with ribs for catching the fingers. It should be noted that a lock lever for the opening and closing operations of the opening cover 11 may be provided on this grip 111.

On the other hand, the grips 121 to 151 provided at the decorative covers 12F to 15F of the first to fourth sheet cassettes 12 to 15 include grip bars that can be gripped both from above and from below. Thus, the user can grip the grips 121 to 151 either with the back of his or her hand faced up or with the palm of his or her hand faced up. For example, even a user sitting on a wheelchair can grip the grip according to his or her own physical characteristic.

The grip 121 of the first sheet cassette 12 is described with reference to FIG. 3. It should be noted that the other grips 131, 141 and 151 have the same construction as the one described below. The grip 121 includes left and right rib portions 122L, 122R, a bar portion 123 and a hollow portion 124. Here, the grip 121 is shown to be arranged at a vertical middle position of the first sheet cassette 12 in thickness direction, but it may be arranged at an upper or lower positions.

The rib portions 122L, 122R project from the inclined surfaces 105L, 105R of the recessed part 105 in directions toward each other for improving the mechanical strength of the bar portion 123. The bar portion 123 is a bar-like member transversely extending to bridge the left and right edges of the recessed part 105 and having a front surface substantially in flush with the projecting flat surface 101. The hollow portion 124 is a space present at the back side of the bar portion 123 and permitting the user to insert his or her fingers from above or below.

The colored portion 12A having a color different from that of the projecting flat surface 101 is provided on the front surface of the bar portion 123. This colored portion 12A is for enabling the user to clearly visually confirm the position of the grip 121 based on the color difference of the front surface of the grip 121 in addition to the visual effect of the arcuate inclined surface 102, the left and right inclined surfaces 103, 104. Accordingly, the color of the colored portion 12A is preferably largely different from that of the other parts. For example, a lightness difference between the color of the colored portion 12A and that of the other parts of the projecting flat surface 101 is preferably 3 or greater in the Munsell value of the Munsell chart (JIS). In this way, the colored portion 12A can be more clearly recognized. It should be noted that this holds true for the other colored portions 13A to 15A.

The user can withdraw the first sheet cassette 12 from the apparatus main body 10 by gripping such a grip 121 from above or below and pulling it forward. This holds true for the second to fourth sheet cassettes 13 to 15. It should be noted that the grips 121 to 151 may be provided with lock levers for the withdrawing operations.

A cassette display 125 for displaying the level number of this cassette and the size of accommodated sheets is provided at the right end side of the decorative cover 12F of the first sheet cassette 12. The level number is a number used as an identifier, for example, when the user manually selects the sheet cassette on the operation panel 50.

The emblem 106 (display portion) for displaying the manufacturer or brand is attached near the transverse middle position of the arcuate inclined surface 102. The emblem 106 may be replaced by a display plate displaying other information. Alternatively, a transparent window may be provided at this position to display, for example, a part of the toner container mounted in the apparatus main body 10. By providing the display portion for displaying specified information on the copier 1 on or near the arcuate inclined surface 102 easier to see for the user in this way, the displayed information can be more easily impressed on the user.

According to the copier 1 constructed as above, the visibility of the grips 111 to 151 present at the apparatus front cover 100 can be improved by providing the apparatus front cover 100 with the projecting flat surface 101, the arcuate inclined surface 102 and left and right inclined surfaces 103, 104 formed around the projecting flat surface 101, and the inclined surfaces 105L, 105R of the recessed part 105.

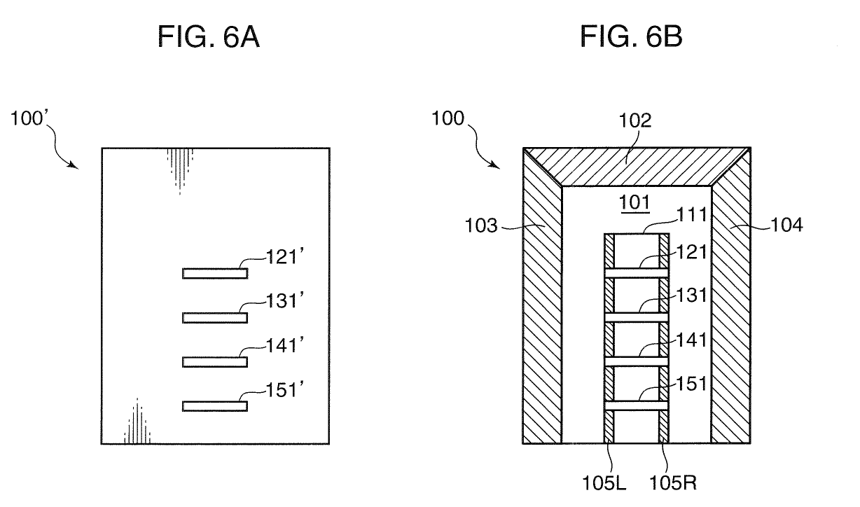

FIG. 6A is a front view schematically showing a flat apparatus front cover 100′ having no particularly striking inclined surface. In this case, only an impression that the wide flat surface called the apparatus front cover 100′ is merely present on the front surface of the copier 1 tends to be given to a viewer. Thus, even if grips 121′ to 151′ of the sheet cassettes are present at the apparatus front cover 100′, accessibility thereto cannot be said to be good. Further, the grip of the opening cover is visually embedded in the plane of the apparatus front cover 100′ and the position thereof tends to be difficult to find.

On the other hand, as shown in FIG. 6B, by forming the projecting flat surface 101 surrounded by the three inclined surfaces, i.e. the arcuate inclined surface 102, the left and right inclined surfaces 103, 104, a visual effect of looking as if another plane were present in the plane called the apparatus front cover 100 can be created. This makes it easier to concentrate the user's gaze to the middle part of the apparatus front cover 100.

Since the grips 111 to 151 are vertically arranged one above the other in such a middle part, the user can more easily recognize them, accessibility to the grips 111 to 151 can be improved and, consequently, operability at the time of sheet replenishment or jam process can be improved. Such an effect is further intensified by forming the inclined surfaces 105L, 105R in the arrangement direction of the grips 111 to 151 and providing the colored portions 12A to 15A. Further, by having the three inclined surfaces, a visual impression that the copier 1 is small can be given and the visual presence of the copier 1 in an office space or the like can be reduced, whereby an impression of a wide open space can be given.

The copier 1 according to the embodiment of the present invention is described above, but the present invention is not limited thereto and may be embodied, for example, as follows.

(1) The above embodiment is described taking the copier 1 as an example of the image forming apparatus. It goes without saying that the present invention is also applicable to other image forming apparatuses such as printers, facsimile machines or complex machines of these.

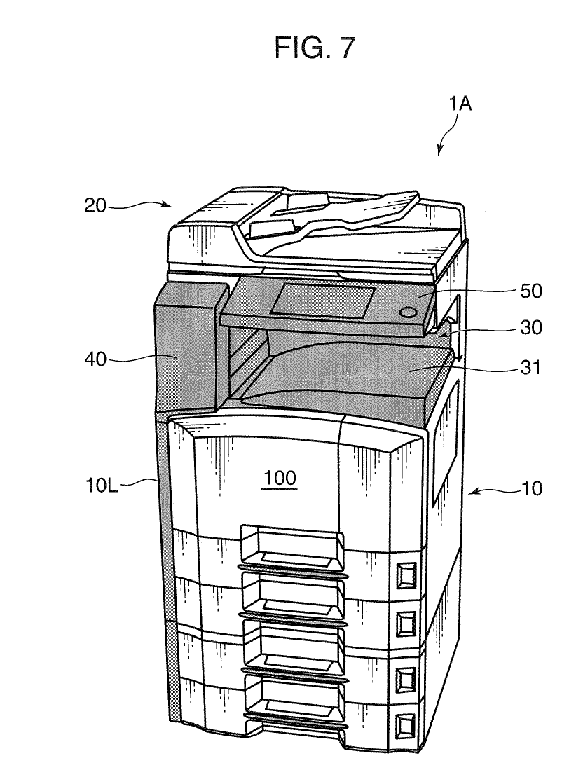

(2) The color of the copier 1 may be a single color, e.g. an ivory color, but preferably has such coloration as to make the discharge unit 30 of the internal discharge type striking. FIG. 7 is a perspective view showing a copier 1A in which the visibility of the discharge unit 30 is improved by colors. Here is shown an example in which the discharge unit 30 (discharge tray 31), the supporting column 40, the operation panel 50 and a left edge portion 10L of the apparatus main body 10 have a deeper (darker) color than other parts. By doing so, it is possible not only to improve the design by two-tone colors, but also to make the discharge unit 30, which is structurally difficult to find by being of the internal discharge type, more striking by colors in addition to the shape effect of the above arcuate inclined surface 102.

In this case, the color of the discharge tray 31 is preferably selected from a range of 1 to 5 in lightness represented by Munsell values of the Munsell chart (JIS). By letting the discharge tray 31 have such a dark color, contrast with white sheets can be improved, wherefore the user can more easily recognize the sheet discharged to the discharge unit 31.

Further, in FIG. 7, a difference in lightness between the color of the discharge tray 31, the supporting column 40, the operation panel 50 and the left edge portion 10L of the apparatus main body 10 and the color of the apparatus front cover 100 is preferably 3 or greater in the Munsell value of the Munsell chart (JIS). By having such a lightness difference, contrast between the vicinity of the discharge unit 30 and the apparatus front cover 100 can be improved and the discharge unit 30 can be made even more striking.

(3) In the above embodiment, the colored portions 12A to 15A are provided on the grips 121 to 151. However, these colored portions 12A to 15A may be omitted. Conversely, in addition to the colored portions 12A to 15A, a similar colored portion may be provided in the vicinity of the grip 111 of the opening cover 11.

(4) In the above embodiment, the projecting flat surface 101 is surrounded by the three inclined surfaces, i.e. the arcuate inclined surface 102, the left and right inclined surfaces 103, 104. In addition, a fourth inclined surface extending from the bottom side of the projecting flat surface 101 toward the bottom peripheral edge of the apparatus front cover 100 may be provided.

The specific embodiment described above mainly embraces inventions having the following constructions.

An image forming apparatus according to one aspect of the present invention comprises a box-shaped apparatus main body internally provided with an image forming assembly and a sheet feeding assembly; an apparatus front cover located on the front surface of the apparatus main body and having a plurality of unit cover members that can be opened forward and are vertically arranged one above the other; and grips provided on the respective unit cover members and used to open the unit cover members, wherein the apparatus front cover has a rectangular shape when the front surface of the apparatus main body is viewed from front and includes a projecting flat surface projecting more forward than the peripheral edges of the apparatus front cover and inclined surfaces formed to extend from the left, right and upper sides of the projecting flat surface toward the peripheral edges of the apparatus front cover; and the grips are vertically arranged one above the other on the projecting flat surface.

According to this construction, the apparatus front cover has the projecting flat surface surrounded by the inclined surfaces at the left, right and upper sides. Thus, gaze is likely to concentrate on the projecting flat surface. Since the grips of the plurality of unit covers are vertically arranged one above the other on the projecting flat surface, the visibility of the grips by a user can be improved. Further, the geometric center of the image forming apparatus is fixed at the center of the apparatus front cover by the presence of the inclined surfaces, thereby being able to give a small visual impression.

In the above construction, the grips are preferably arranged at a transverse middle position of the projecting flat surface.

According to this construction, the visibility of the grips can be further improved since the grips are arranged at the transverse middle position of the projecting flat surface where gaze is likely to concentrate.

In the above construction, it is preferable that an opening cover which covers the image forming assembly and can be opened forward and a sheet cassette mounted into the apparatus main body in such a manner as to be withdrawable forward are further provided; and that the unit cover members include the opening cover and a decorative cover on the front surface of the sheet cassette.

According to this construction, the visibility of the respective grips of the opening cover and the sheet cassette, which are opened in different manners, can be improved.

In this case, the grip provided on the sheet cassette preferably includes a grip portion that can be gripped both from above and from below.

According to this construction, the user can grip the grip portion of the sheet cassette either with the back of his or her hand faced up or with the palm of his or her hand faced up. Therefore, the user can grip the grip portion according to his or her physical characteristic and sheet replenishment can be smoothly performed.

It is also preferable that a recessed part vertically extending over the opening cover and the decorative cover is formed at a transverse middle position of the projecting flat surface; and that the respective grips are arranged in the recessed part.

According to this construction, the positions of the grips can be made even more striking since the respective grips are provided in the recessed part formed at the transverse middle position of the projecting flat surface.

In this case, a pair of inclined surfaces whose widths are increased from the bottom surface of the recessed part toward opening edges of the recessed part are more preferably formed at least at the left and right sides of the recessed part.

According to this construction, both the inclined surfaces present at the left and right sides of the apparatus front cover and the pair of inclined surfaces formed at this recessed part visually further intensify the transverse middle position of the projecting flat surface where the grips are aligned.

In this construction, it is preferable that a plurality of decorative covers are vertically arranged one above the other and one opening cover is arranged above the decorative covers; that the recessed part is formed by recessing transverse middle parts of the decorative covers by a specified width over the entire vertical thicknesses of the decorative covers and by recessing a bottom section of a transverse middle part of the opening cover by the specified width; that the grip provided on the decorative cover of each sheet cassette includes a grip bar bridging the left and right opening edges of the recessed part and having a front surface substantially in flush with the projecting flat surface; and that the grip of the opening cover includes a catch portion provided at the recessed part.

According to this construction, the projected area of the image forming apparatus does not increase since the grips of the sheet cassettes do not project from the projecting flat surface. Further, since the grip of the opening cover includes the catch portion utilizing the recessed portion near the bottom edge of the opening cover, this grip does not project from the projecting flat surface. Thus, in the image forming apparatus in which a plurality of decorative covers (i.e. sheet cassettes) are vertically arrange one above the other and one opening cover is arranged above the decorative covers, the visibility of the grips can be improved while maintaining a compact configuration, utilizing the recessed part of the projecting flat surface.

In any of the above constructions, it is preferable that colored portions having a color different from that of the projecting flat surface are provided on or near the front surfaces of some or all of the grips; and that a lightness difference between the color of the colored portions and that of other parts of the projecting flat surface is 3 or greater in the Munsell value of the Munsell chart (JIS).

According to this construction, the user can clearly see the positions of the grips by the color difference on or near the front surfaces of the grips in addition to the visual effect of the inclined surfaces present at the apparatus front cover.

In the above construction, angles of inclination of the inclined surfaces of the apparatus front cover are preferably selected from such a range that angles of intersection with the projecting flat surface are 30° to 70°. Further, the widths of the inclined surfaces at the left and right sides of the projecting flat surface are preferably about 0.05 to 0.3 times as large as the width of the projecting flat surface in transverse direction.

In the above construction, the image forming apparatus is preferably an image forming apparatus of the internal discharge type comprising an image reader arranged atop the apparatus main body for reading a document image and a discharge unit which is provided between the apparatus main body and the image reader, to which a sheet after image formation is discharged, and is open at least at front for the removal of the sheet.

According to the image forming apparatus of the present invention as described above, the visibility of the grips present at the apparatus front cover can be improved by having the above inclined surfaces. Thus, the user can have better accessibility to the grips of the unit cover members such as the opening cover and the sheet cassettes, whereby better operability can be given. Further, since a small visual impression can be given, the presence of the image forming apparatus in an office space or the like can be reduced and an impression of a wide open space can be given.

This application is based on patent application No. 2007-011339 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus, comprising:
a box-shaped apparatus main body internally provided with an image forming assembly and a sheet feeding assembly;
an apparatus front cover located on the front surface of the apparatus main body and having a plurality of unit cover members that can be opened forward and are vertically arranged one above the other; and
grips provided on the respective unit cover members and used to open the unit cover members,
wherein:
the apparatus front cover has a rectangular shape when the front surface of the apparatus main body is viewed from front and includes a projecting flat surface projecting more forward than the peripheral edges of the apparatus front cover and inclined surfaces formed to extend from the left, right and upper sides of the projecting flat surface toward the peripheral edges of the apparatus front cover; and
the grips are vertically arranged one above the other on the projecting flat surface.

2. An image forming apparatus according to claim 1, wherein the grips are arranged at a transverse middle position of the projecting flat surface.

3. An image forming apparatus according to claim 1, further comprising:
an opening cover which covers the image forming assembly and can be opened forward; and
a sheet cassette mounted into the apparatus main body in such a manner as to be withdrawable forward;
wherein the unit cover members include the opening cover and a decorative cover on the front surface of the sheet cassette.

4. An image forming apparatus according to claim 3, wherein the grip provided on the sheet cassette includes a grip portion that can be gripped both from above and from below.

5. An image forming apparatus according to claim 3, wherein:
a recessed part vertically extending over the opening cover and the decorative cover is formed at a transverse middle position of the projecting flat surface; and
the respective grips are arranged in the recessed part.

6. An image forming apparatus according to claim 5, wherein a pair of inclined surfaces whose widths are increased from the bottom surface of the recessed part toward opening edges of the recessed part are formed at least at the left and right sides of the recessed part.

7. An image forming apparatus according to claim 5, wherein:
a plurality of decorative covers are vertically arranged one above the other and one opening cover is arranged above the decorative covers;
the recessed part is formed by recessing transverse middle parts of the decorative covers by a specified width over the entire vertical thicknesses of the decorative covers and by recessing a bottom section of a transverse middle part of the opening cover by the specified width;
the grip provided on the decorative cover of each sheet cassette includes a grip bar bridging the left and right opening edges of the recessed part and having a front surface substantially in flush with the projecting flat surface; and
the grip of the opening cover includes a catch portion provided at the recessed part.

8. An image forming apparatus according to claim 1, further comprising colored portions provided on or near the front surfaces of some or all of the grips and having a color different from that of the projecting flat surface, wherein a lightness difference between the color of the colored portions and that of other parts of the projecting flat surface is 3 or greater in the Munsell value of the Munsell chart (JIS).

9. An image forming apparatus according to claim 1, wherein angles of inclination of the inclined surfaces of the apparatus front cover are selected from such a range that angles of intersection with the projecting flat surface are 30° to 70°.

10. An image forming apparatus according to claim 1, wherein the widths of the inclined surfaces at the left and right sides of the projecting flat surface are about 0.05 to 0.3 times as large as the width of the projecting flat surface in transverse direction.

11. An image forming apparatus according to claim 1, further comprising:
an image reader arranged atop the apparatus main body for reading a document image; and
a discharge unit which is provided between the apparatus main body and the image reader, to which a sheet after image formation is discharged, and is open at least at front for the removal of the sheet.
